(19) United States
(12) Patent Application Publication
(10) Pub. No.: US 2012/0017788 A1
(43) Pub. Date: Jan. 26, 2012

(54) PLATE CYLINDER, PRINTING APPARATUS, AND METHOD OF FORMING PLATE CYLINDER

(75) Inventor: Tomohide Jozaki, Kanagawa (JP)

(73) Assignee: Sony Corporation, Tokyo (JP)

(21) Appl. No.: 13/181,929

(22) Filed: Jul. 13, 2011

(30) Foreign Application Priority Data
Jul. 21, 2010 (JP) 2010-163993

(51) Int. Cl. B41N 1/00; B41C 3/00

(52) U.S. Cl. 101/395; 101/401.1

(57) ABSTRACT

A plate cylinder includes a cylindrical member, and a pattern forming plate configured by forming a predetermined pattern for printing on a flat plate-shaped substrate using microfabrication. The pattern forming plate is bent, and wound around and joined to an outer peripheral surface of the cylindrical member.

### BACKGROUND

The present disclosure relates to a technical field of a plate cylinder, a printing apparatus, and a method of forming a plate cylinder. Specifically, the present disclosure relates to a technical field of forming a precise pattern for printing without causing an increase in manufacturing costs, by winding and joining a pattern forming plate, in which a predetermined pattern for printing is formed by microfabrication, around the outer peripheral surface of a cylindrical member.

There are apparatuses for forming minute wiring patterns for flat panel displays (glass substrate) such as liquid crystal displays (LCDs), plasma display panels (PDPs), and electroluminescence (EL) displays.

In such apparatuses, there is an apparatus which applies photolithography techniques or etching techniques which are semiconductor manufacturing processes. However, this apparatus has a complex configuration since an advanced exposure unit or vacuum technology is used.

In recent years, printing apparatuses which use printable electronics technology for forming minute wiring patterns by printing have been developed.

As the printing apparatuses which use printable electronics technology, for example, there is an apparatus that performs gravure offset printing. In this printing apparatus, a cylindrical plate cylinder having a predetermined pattern formed on the outer peripheral surface is rotated, and ink is transferred on a material to be printed via a blanket roll, thereby performing printing.

The plate cylinder is generally configured by forming a predetermined pattern for printing for forming a wiring pattern on the outer peripheral surface of a cylindrical glass member (for example, see Japanese Unexamined Patent Application Publication No. 2004-223724). The pattern of the plate cylinder is formed by applying a resist on the outer peripheral surface of a cylindrical base material which becomes the plate cylinder, and exposing, developing, and heating and curing the applied resist.

### SUMMARY

However, in recent years, even though a glass substrate used for liquid crystal displays or the like has a tendency to increase in size, there is a demand for a high printing precision of about 1 μm to several μm as the printing precision of the wiring pattern.

However, in the method of forming the wiring pattern by applying the resist on the outer peripheral surface of the cylindrical base material which becomes the plate cylinder and performing exposure as described above, since the resist is applied on the circumferential surface, there are problems in that it is difficult to ensure uniformity of the resist, and processing precision of the pattern is easily degraded.

In addition, performing exposure and development on the cylindrical surface is difficult work, so that there is a problem in that manufacturing costs are increased.

It is desirable to provide a plate cylinder, a printing apparatus, and a method of forming a plate cylinder capable of forming a precise pattern for printing without causing an increase in manufacturing costs by overcoming the above problems.

According to an embodiment of the present disclosure, there is provided a plate cylinder including: a cylindrical member; and a pattern forming plate configured by forming a predetermined pattern for printing on a flat plate-shaped substrate using microfabrication, wherein the pattern forming plate is bent, and wound around and joined to an outer peripheral surface of the cylindrical member.

Therefore, in the plate cylinder, the pattern for printing is formed on the flat plate-shaped substrate using microfabrication.

In the plate cylinder described above, it is preferable that the cylindrical member and the pattern forming plate be formed of a glass material.

Since the cylindrical member and the pattern forming plate are formed of a glass material, the coefficients of thermal expansion of the cylindrical member and the pattern forming plate are reduced.

In the plate cylinder described above, it is preferable that the cylindrical member and the pattern forming plate be formed of the same material.

Since the cylindrical member and the pattern forming plate are formed of the same material, the coefficients of thermal expansion of the cylindrical member and the pattern forming plate become equal to each other.

In the plate cylinder described above, it is preferable that the pattern forming plate be formed by etching and thinning the substrate.

Since the pattern forming plate is formed by etching and thinning the substrate, the substrate is etched and thinned.

In the plate cylinder described above, it is preferable that the pattern forming plate be joined to the outer peripheral surface of the cylindrical member by an adhesive of which the adhesion is degraded by the addition of a peeling agent, the irradiation of UV rays, heating, or cooling.

Since the pattern forming plate is joined to the outer peripheral surface of the cylindrical member by the adhesive of which the adhesion is degraded by the addition of a peeling agent, the irradiation of UV rays, heating, or cooling, the pattern forming plate can be peeled off from the cylindrical member by performing the addition of a peeling agent, the irradiation of UV rays, heating, or cooling on the adhesive.

In the plate cylinder described above, it is preferable that the predetermined pattern be formed of a plurality of recessed portions that communicate with the outer peripheral surface of the cylindrical member, and the pattern forming plate has a smaller adhesion to ink filling the recessed portions than that of the cylindrical member.

Since the pattern forming plate has a smaller adhesion to ink filling the recessed portions of the predetermined pattern than that of the cylindrical member, transferability of the ink from the plate cylinder is enhanced.

According to another embodiment of the present disclosure, there is provided a printing apparatus including: a plate cylinder which includes a cylindrical member, and a pattern forming plate configured by forming a predetermined pattern for printing on a flat plate-shaped substrate using microfabrication, the pattern forming plate being bent, and wound around and joined to an outer peripheral surface of the cylindrical member, wherein printing is performed on a material to be printed as the plate cylinder is rotated.

Therefore, in the printing apparatus, the pattern for printing is formed on the flat plate-shaped substrate using microfabrication.

According to still another embodiment of the present disclosure, there is provided a method of forming a plate cylinder including: forming a pattern forming plate by forming a predetermined pattern for printing on a flat plate-shaped substrate using microfabrication; and bending the pattern forming plate and winding and joining the pattern forming plate to an outer peripheral surface of a cylindrical member so as to be formed.

Therefore, in the method of forming a plate cylinder, the pattern forming plate having the pattern for printing formed on the flat plate-shaped substrate using microfabrication is wound around the outer peripheral surface of the cylindrical member.

A plate cylinder according to an embodiment of the present disclosure includes a cylindrical member; and a pattern forming plate configured by forming a predetermined pattern for printing on a flat plate-shaped substrate using microfabrication, wherein the pattern forming plate is bent, and wound around and joined to an outer peripheral surface of the cylindrical member.

Therefore, the pattern for printing may be formed on the flat plate-shaped substrate, and the pattern for printing does not have to be formed on the outer peripheral surface of a cylindrical base material, so that a precise pattern for printing can be formed without causing an increase in manufacturing costs.

In the plate cylinder according to the embodiment of the present disclosure, the cylindrical member and the pattern forming plate are formed of a glass material.

Therefore, expansion and contraction due to a temperature change is suppressed and thus enhancement of processing precision and high precision of the pattern can be ensured. In addition, suppression of breaking and cracking of the pattern forming plate can be achieved.

In the plate cylinder according to the embodiment of the present disclosure, the cylindrical member and the pattern forming plate are formed of the same material.

Therefore, the coefficients of thermal expansion of the cylindrical member and the pattern forming plate become equal to each other. Therefore, there is no difference between the rates of expansion and between the rates of contraction of the cylindrical member and the pattern forming plate due to a temperature change, so that enhancement of processing precision and an increase in yield can be achieved.

In the plate cylinder according to the embodiment of the present disclosure, the pattern forming plate is formed by etching and thinning the substrate.

Therefore, forming and thinning of the pattern forming plate can be easily performed, and degree of freedom in designing the thickness of the pattern forming plate can be enhanced.

In the plate cylinder according to the embodiment of the present disclosure, the pattern forming plate is joined to the outer peripheral surface of the cylindrical member by an adhesive of which the adhesion is degraded by the addition of a peeling agent, the irradiation of UV rays, heating, or cooling.

Therefore, the plate cylinder does not have to be replaced when breaking or damage occurs in the pattern forming plate, and only the pattern forming plate may be replaced. Therefore, a reduction in costs during a printing operation using the plate cylinder can be achieved.

In the plate cylinder according to the embodiment of the present disclosure, the predetermined pattern is formed of a plurality of recessed portions that communicate with the outer peripheral surface of the cylindrical member, and the pattern forming plate has a smaller adhesion to ink filling the recessed portions than that of the cylindrical member.

Therefore, good transferability of ink from the plate cylinder is ensured, thereby ensuring printing precision of a material to be printed.

A printing apparatus according to another embodiment of the present disclosure, includes: a plate cylinder which includes a cylindrical member, and a pattern forming plate configured by forming a predetermined pattern for printing on a flat plate-shaped substrate using microfabrication, the pattern forming plate being bent, and wound around and joined to an outer peripheral surface of the cylindrical member, wherein printing is performed on a material to be printed as the plate cylinder is rotated.

Therefore, the pattern for printing may be formed on the flat plate-shaped substrate, and the pattern for printing does not have to be formed on the outer peripheral surface of a cylindrical base material, so that a precise pattern for printing can be formed without causing an increase in manufacturing costs.

A method of forming a plate cylinder according to still another embodiment of the present disclosure, includes: forming a pattern forming plate by forming a predetermined pattern for printing on a flat plate-shaped substrate using microfabrication; and bending the pattern forming plate and winding and joining the pattern forming plate to an outer peripheral surface of a cylindrical member so as to be formed.

Therefore, the pattern for printing may be formed on the flat plate-shaped substrate, and the pattern for printing does not have to be formed on the outer peripheral surface of a cylindrical base material, so that a precise pattern for printing can be formed without causing an increase in manufacturing costs.

### BRIEF DESCRIPTION OF THE DRAWINGS

FIG. 1 is a side view schematically showing a printing apparatus to show a plate cylinder, the printing apparatus, and a method of forming a plate cylinder according to an embodiment of the present disclosure together with FIGS. 2 to 23.

FIG. 2 is a perspective view of the plate cylinder in which a part of a pattern forming plate is separated from a cylindrical member.

FIG. 3 is an enlarged cross-sectional view showing a substrate to show the method of forming a plate cylinder together with FIGS. 4 to 17.

FIG. 4 is a cross-sectional view schematically showing a state where a chromium film is applied to the substrate, subsequently to FIG. 3.

FIG. 5 is a cross-sectional view schematically showing a state where a resist is applied to the chromium film, subsequently to FIG. 4.

FIG. 6 is an enlarged cross-sectional view showing a state where a part of the resist is removed and a pattern which becomes a base of a pattern for printing is formed, subsequently to FIG. 5.

FIG. 7 is an enlarged cross-sectional view showing a state where the chromium film is etched using the resist as a mask, subsequently to FIG. 6.

FIG. 8 is an enlarged cross-sectional view showing a state where the resist is peeled off by plasma asking, subsequently to FIG. 7.

FIG. 9 is an enlarged cross-sectional view showing a state where the substrate is etched, subsequently to FIG. 8.

FIG. 10 is an enlarged cross-sectional view showing a state where the chromium film is removed and a pattern forming plate is formed, subsequently to FIG. 9.

FIG. 11 is an enlarged cross-sectional view showing a state where a resist is applied on the pattern forming plate, subsequently to FIG. 10.

FIG. 12 is an enlarged cross-sectional view showing a state where a protective sheet is attached to the resist, subsequently to FIG. 11.

FIG. 13 is an enlarged cross-sectional view showing a state where the pattern forming plate is etched-back and thinned and a winding body is formed, subsequently to FIG. 12.

FIG. 14 is an enlarged cross-sectional view showing a state where an adhesive is applied to the cylindrical member, subsequently to FIG. 13.

FIG. 15 is an enlarged cross-sectional view showing a state where the winding body is wound around the cylindrical member, subsequently to FIG. 14.

FIG. 16 is an enlarged cross-sectional view showing a state where the winding body is wound around the cylindrical member, subsequently to FIG. 15.

FIG. 17 is an enlarged cross-sectional view showing a state where the plate cylinder is formed, subsequently to FIG. 16.

FIG. 18 is an enlarged cross-sectional view showing a state where a pattern forming plate is etched-back and thinned and a winding body is formed to show a modified example of the method of forming a plate cylinder together with FIGS. 19 to 23.

FIG. 19 is an enlarged cross-sectional view showing a state where an adhesive is applied to the cylindrical member, subsequently to FIG. 18.

FIG. 20 is an enlarged cross-sectional view showing a state where the winding body is wound around the cylindrical member, subsequently to FIG. 19.

FIG. 21 is an enlarged cross-sectional view showing a state where the winding body is wound around the cylindrical member, subsequently to FIG. 20.

FIG. 22 is an enlarged cross-sectional view showing a state where a plate cylinder is formed, subsequently to FIG. 21.

FIG. 23 is an enlarged cross-sectional view showing a pattern for printing.

### DETAILED DESCRIPTION OF EMBODIMENTS

Hereinafter, a plate cylinder, a printing apparatus, and a method of forming a plate cylinder according to embodiments of the present disclosure will be described with reference to the accompanying drawings.

In the exemplary embodiment of the present disclosure, the printing apparatus is applied to a printing apparatus which performs gravure offset printing, the plate cylinder is applied to a plate cylinder provided in the printing apparatus which performs gravure offset printing, and the method of forming a plate cylinder is applied to a method of forming the plate cylinder provided in the printing apparatus which performs gravure offset printing.

The application range of the plate cylinder, the printing apparatus, and the method of forming a plate cylinder according to this embodiment of the present disclosure is not limited to the printing apparatus which performs gravure offset printing, the plate cylinder provided in the printing apparatus, and the method of forming the plate cylinder. The printing apparatus, the plate cylinder, and the method of forming a plate cylinder according to this embodiment of the present disclosure may be widely applied to various printing apparatuses which perform printing by rotating a plate cylinder, plate cylinders provided in those various printing apparatuses, and methods of forming such plate cylinders.

In the following description, as an example, a direction in which a material to be printed such as a glass substrate is disposed is an up and down direction. However, this embodiment of the present disclosure is not limited to the direction.

### Configuration of Printing Apparatus

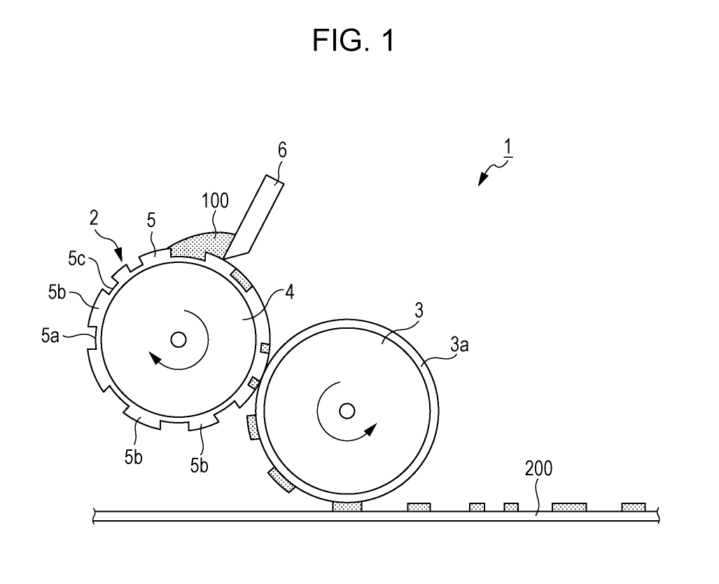

A printing apparatus 1 includes a cylindrical plate cylinder 2 and a blanket roll 3 which is rotated along with the rotation of the plate cylinder 2 (see FIG. 1).

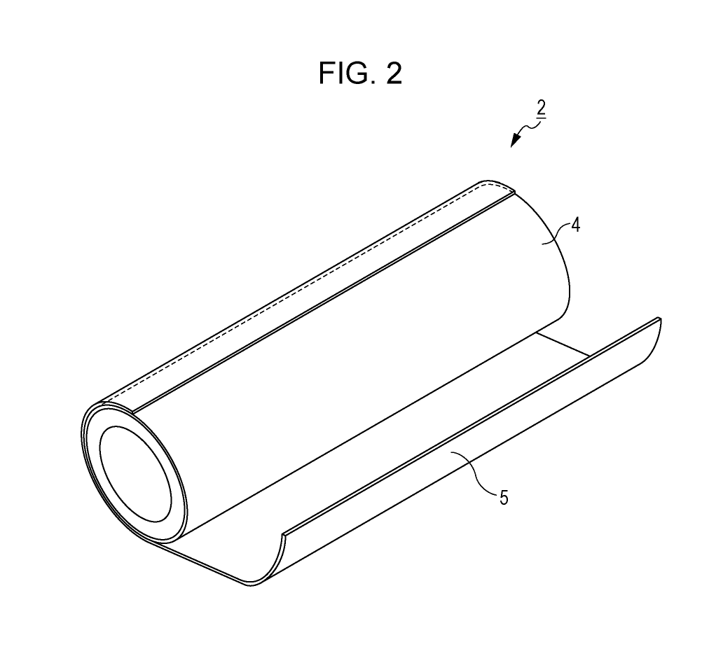

The plate cylinder 2 is made of a cylindrical member 4 and a pattern forming plate 5 wound around the outer peripheral surface of the cylindrical member 4 and joined thereto by an adhesive (see FIGS. 1 and 2).

The cylindrical member 4 is formed of, for example, a glass material such as quartz glass.

The pattern forming plate 5 is formed of the same material as the cylindrical member, for example, a glass material such as quartz glass. The pattern forming plate 5 is configured of a base portion 5a positioned on the cylindrical member 4 side, and a plurality of protruding portions 5b, 5b, . . . protruding outward from the base portion 5a, and a predetermined pattern 5c is formed by a plurality of recessed portions between the protruding portions 5b, 5b, . . . .

Each recessed portion of the pattern 5c is filled with ink 100 for printing. The ink 100 is supplied from an ink supply apparatus (not shown) and fills each recessed portion of the pattern 5c, and unnecessary ink 100 is scraped out by a blade 6.

It is preferable that the cylindrical member 4 and the pattern forming plate 5 have the same material. However, they may be formed of different materials from each other as long as the coefficients of thermal expansion thereof are substantially equal to each other. In addition, it is preferable that the coefficients of thermal expansion of the cylindrical member 4 and the pattern forming plate 5 be equal to each other, and the cylindrical member 4 and the pattern forming plate 5 may be formed of a material other than the glass material, for example, a metal material or a ceramic material.

Here, it is more preferable that the cylindrical member 4 and the pattern forming plate 5 be formed of a material having a low coefficient of thermal expansion, and it is optimal to use a glass material as a material which ensures a low coefficient of thermal expansion and is less likely to cause breaking and cracking. As the cylindrical member 4 and the pattern forming plate 5 are made of the glass material, expansion and contraction due to a temperature change is suppressed and thus enhancement of processing precision and high precision of the pattern 5c can be ensured. In addition, suppression of breaking and cracking of the pattern forming plate 5 can be achieved.

In addition, as the cylindrical member 4 and the pattern forming plate 5 are formed of the same material, the coefficients of thermal expansion of the cylindrical member 4 and the pattern forming plate 5 become equal to each other. Therefore, there is no difference between the rates of expansion and between the rates of contraction of the cylindrical member 4 and the pattern forming plate 5 due to a temperature change, so that enhancement of processing precision and an increase in yield can be achieved.

The blanket roll 3 is formed in a cylindrical shape, and has a transferring portion 3a formed of a material such as rubber on the outer peripheral portion. The blanket roll 3 is rotated along with the rotation of the plate cylinder 2 and is rotated at the same angular velocity as that of the plate cylinder 2. As the blanket roll 3 is rotated, the ink 100 that fills each recessed portion of the pattern 5c in the plate cylinder 2 is received by the transferring portion 3a.

The plate cylinder 2, the blanket roll 3, and the blade 6 are movable in the up and down direction or in the left and right direction (printing direction) in one body.

A material to be printed 200 is a transparent glass plate used for, for example, liquid crystal displays, and a wiring pattern is printed on the material to be printed 200 by the printing apparatus 1. As the material to be printed 200, for example, a flat plate-shaped member formed of resin or metal may be used. Here, it is preferable that the same material as that of the plate cylinder 2 and the blanket roll 3, or a material having substantially the same coefficient of thermal expansion as that thereof be used as the material to be printed 200, and particularly, it is more preferable that a glass material having a low coefficient of thermal expansion be used.

In the printing apparatus 1 configured as described above, when the plate cylinder 2 in which each recessed portion of the pattern 5c is filled with the ink 100 is rotated, the blanket roll 3 is rotated along with the rotation of the plate cylinder 2 and is moved in the printing direction (to the left) in one body.

The ink 100 is received by the blanket roll 3 as the plate cylinder 2 and the blanket roll 3 are rotated, and the ink 100 received by the blanket roll 3 is transferred onto the material to be printed 200, thereby forming a print pattern.

In the above description, the apparatus for offset printing which has the blanket roll 3 is exemplified as the configuration of the printing apparatus 1. However, as the printing apparatus, an apparatus without the blanket roll 3 other than the apparatus for offset printing may also be employed.

### Method of Forming Plate Cylinder

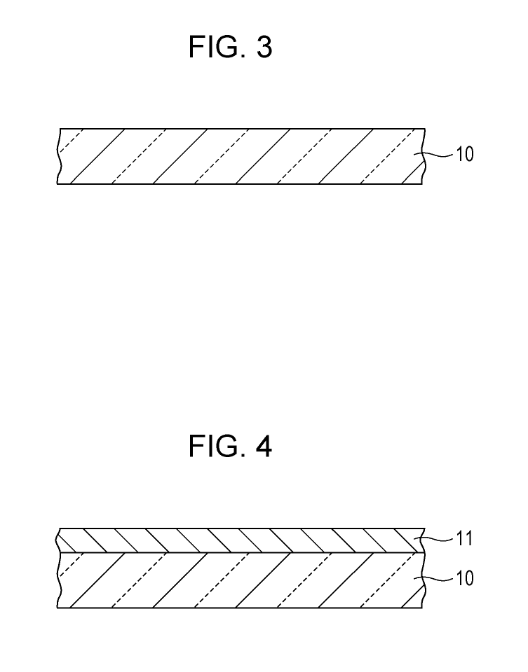

Hereinafter, the method of forming the plate cylinder 2 will be described (see FIGS. 3 to 17).

First, a substrate 10 for forming the pattern forming plate 5 is prepared (see FIG. 3) and is washed. The thickness of the substrate 10 is, for example, 2 mm.

It is preferable that a glass material be used for the substrate 10 as described above in consideration of the coefficient of thermal expansion. Here, since the coefficients of thermal expansion vary according to the kinds of glass material, it is more preferable that the same material as that of the cylindrical member 4 be used as the material of the substrate 10. Particularly, in a case where printing is performed on a large material to be printed 200, so as not to significantly affect printing precision, it is more preferable that the same material as that of the material to be printed 200 be used as the material of the cylindrical member 4 and the pattern forming plate 5.

In addition, as described above, since the coefficients of thermal expansion vary according to the kinds of glass material, in order to suppress expansion and contraction due to a temperature change, it is preferable that a material having a low coefficient of thermal expansion be used as the glass material of the cylindrical member 4 and the pattern forming plate 5. For example, as the glass material, since the coefficient of thermal expansion of quartz glass (synthetic quartz) is 0.51 μm/m·° C. and is thus low, it is suitable to use quartz glass as the glass material of the cylindrical member 4 and the pattern forming plate 5.

Next, forming of a chromium film 11 on the substrate (film formation) is performed by, for example, a sputtering method (see FIG. 4). Forming a film based on sputtering method is performed by applying a DC high voltage between the substrate 10 and the chromium film 11 while introducing an inert gas into vacuum, and thus causing the ionized inert gas to collide with chromium and fly, thereby forming the chromium film 11 on the substrate 10.

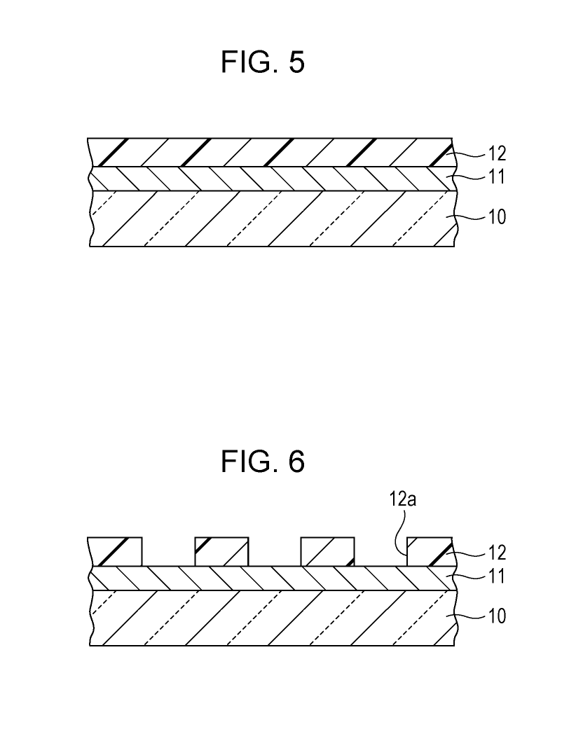

Thereafter, a resist 12 is applied on the chromium film 11 using a spin coater (see FIG. 5), and pre-baking for heating and drying is performed to vaporize the solvent of the resist 12 so as to harden the resist 12.

Thereafter, exposure is performed by irradiating the resist 12 with UV rays, and subsequently, development is performed using a developing liquid to remove parts of the resist 12, thereby forming a pattern 12a which becomes a base of a pattern for printing described later (see FIG. 6). Rinsing is performed for washing after the development. After the pattern 12a is formed, post-baking which is a heating and drying process for vaporizing water or the like and baking the resist 12 is performed.

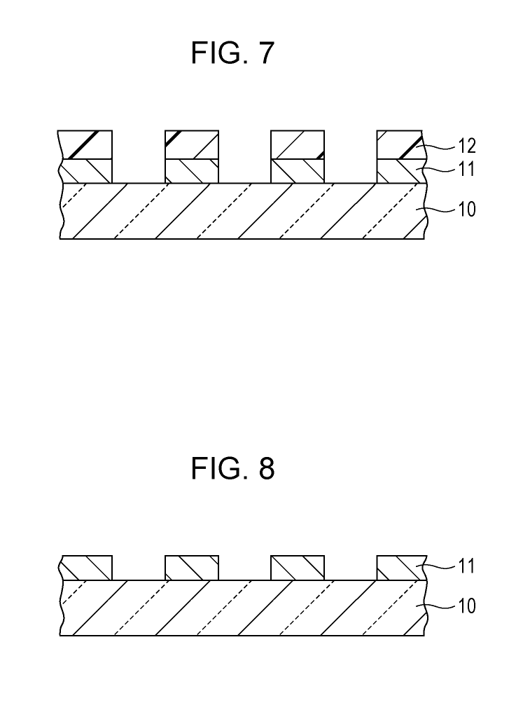

Thereafter, etching is performed on the chromium film 11 using the resist 12 as a mask (see FIG. 7). As the etching, dry etching may be used, or wet etching using a chromium film removing liquid may be used.

Subsequently, the resist 12 is peeled off by plasma ashing (see FIG. 8). The plasma ashing is performed by making oxygen gas into plasma using non-ionizing radiation such as visible light or microwaves, and causing the resist 12 to bond to oxygen radicals in the plasma so as to be vaporized.

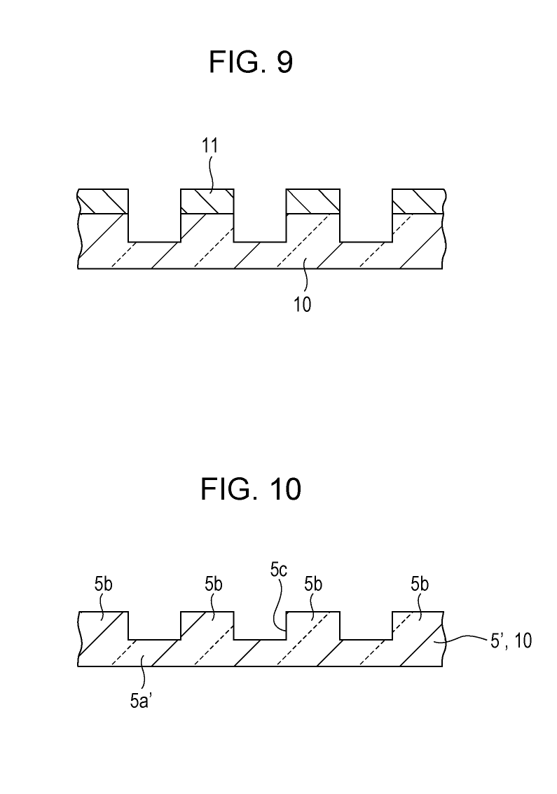

Thereafter, the substrate (quartz glass) 10 is etched (dry-etched) using a plasma etching apparatus (see FIG. 9). There is an etching method using the resist as a mask. However, in a case where quartz glass is used as the substrate 10, selectivity may not be obtained if the resist is used as the mask. Therefore, it is preferable that etching be performed using the chromium film 11 as a mask.

Thereafter, wet etching is performed using a chromium film removing liquid or the like, and the chromium film 11 is removed (see FIG. 10). By removing the chromium film 11, only the substrate 10 is left, thereby forming a pattern forming plate 5′. The pattern forming plate 5′ is configured of a flat plate-shaped base portion 5a′ positioned on the lower side, and a plurality of the protruding portions 5b, 5b, . . . protruding upward from the base portion 5a′, and the predetermined pattern 5c is formed by a plurality of recessed portions between the protruding portions 5b, 5b, . . . .

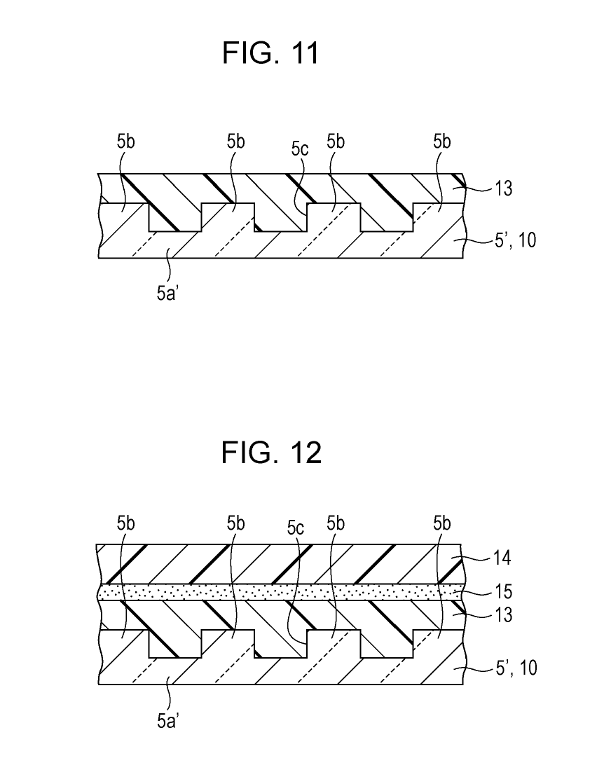

Thereafter, a resist 13 is applied on the surface of the pattern forming plate 5′ using a spin coater (see FIG. 11), and pre-baking for heating and drying is performed to vaporize the solvent of the resist 13 so as to harden the resist 13. As the resist 13, one having a high removing effect using an organic solvent for lift-off processing is used.

Subsequently, a protective sheet 14 is adhered to the surface of the resist 13 by an adhesive 15 (see FIG. 12). The protective sheet 14 has a function of preventing cracking of the pattern forming plate 5 during handling when the pattern forming plate 5′ is thinned as described later. As the protective sheet 14, for example, a polyethylene naphthalate film is used, and as the adhesive 15, for example, a UV curing adhesive is used.

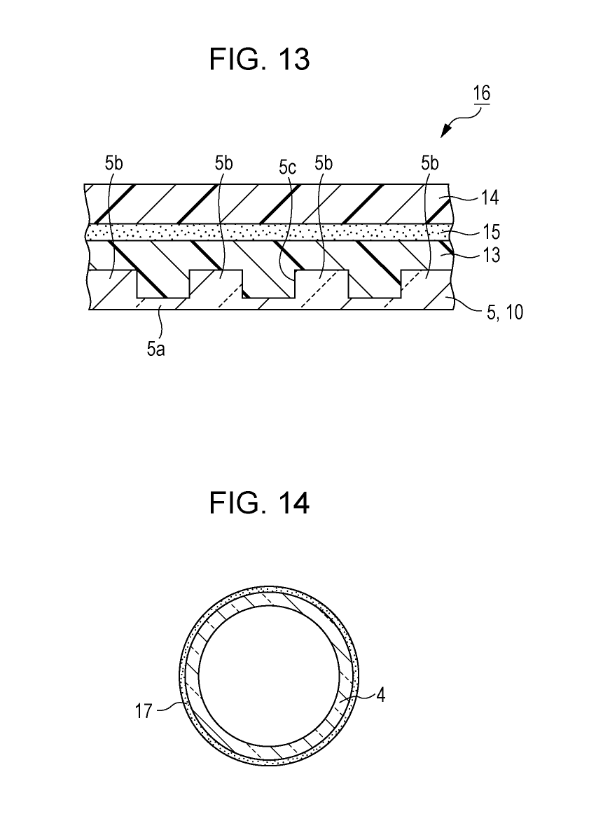

Thereafter, the lower surface (a surface on the opposite side to the side where the resist 13 is applied) of the pattern forming plate 5′ is immersed into a hydrofluoric acid solution having a bubbling function, and etch back is performed to thin the base portion 5a′ of the pattern forming plate 5′ (see FIG. 13). As the base portion 5a′ of the pattern forming plate 5′ is etch-backed and thinned, the pattern forming plate 5 is formed, and the pattern forming plate 5 has a thickness of, for example, 30 μm. In a case where a material having a low etching rate in regard to the hydrofluoric acid solution, such as quartz glass, is used for the substrate 10, for example, the base portion 5a′ may be polished in advance by a polishing apparatus to have a thickness of, for example, 0.7 mm, and thereafter etch back may be performed using the hydrofluoric acid solution to thin the base portion 5a′. As the pattern forming plate 5 is formed by performing etch back and thinning the pattern forming plate 5′ as described above, a winding body 16 made by adhering the resist 13 and the protective sheet 14 onto the pattern forming plate 5 is configured.

Thereafter, the cylindrical member 4 is prepared (see FIG. 14). The cylindrical member 4, for example, has a diameter of 150 mm and an axial length of 300 mm. An adhesive 17, for example, a UV curing adhesive is applied on the outer peripheral surface of the prepared cylindrical member 4.

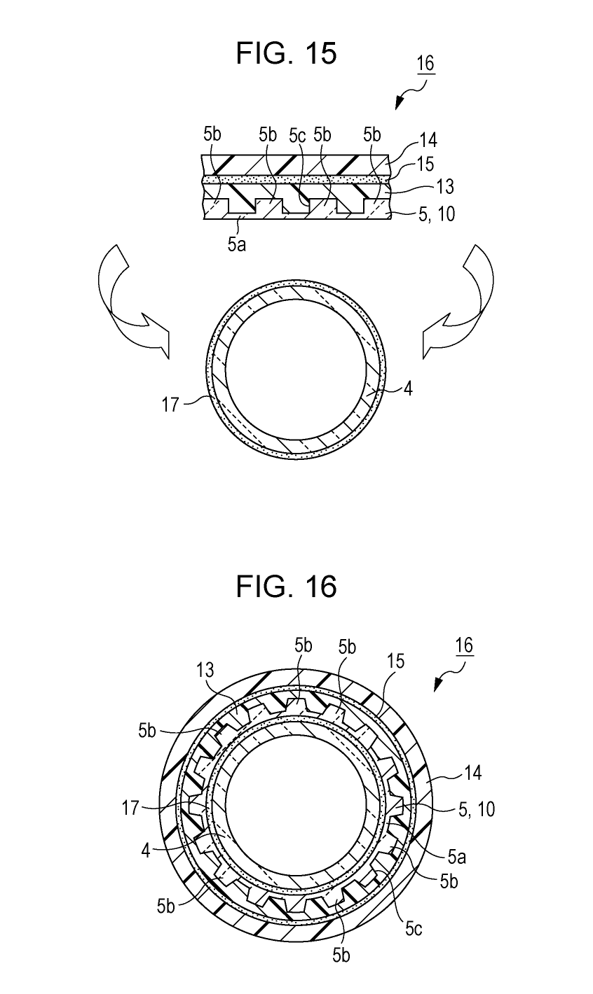

Subsequently, the winding body 16 is bent and wound around the cylindrical member 4 (see FIG. 15). Here, the winding body 16 has to be wound around the cylindrical member 4 with high position precision, and for example, it is preferable that the winding body 16 be irradiated with a laser beam in advance to form a positioning hole and a positioning hole be formed in the cylindrical member 4 in advance. As the positioning holes are formed in the winding body 16 and the cylindrical member 4, a positioning pin (tapered pin) made of glass may be inserted into the two positioning holes so as to accurately position the winding body 16 with respect to the cylindrical member 4.

Thereafter, the adhesive 17 is cured by irradiating the winding body 16 from the outer peripheral surface side with UV rays so as to adhere the winding body 16 to the cylindrical member 4 (see FIG. 16). After adhering the winding body 16 to the cylindrical member 4, the positioning pin is pulled out from the positioning holes.

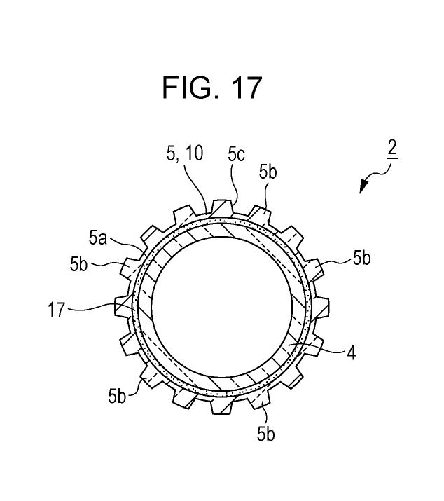

Thereafter, the winding body 16 and the cylindrical member 4 are immersed into an ultrasonic washing tub filled with acetone or a resist peeling agent, and the resist 13 for lift-off is removed (see FIG. 17). At the time of removing the resist 13, the protective sheet 14 is simultaneously peeled off. As the resist 13 of the winding body 16 is removed and the protective sheet 14 is peeled off as described above, the pattern forming plate 5 in which the pattern 5c for printing is formed is left, thereby forming the plate cylinder 2 in which the pattern forming plate 5 is wound around and joined to the cylindrical member 4.

In a state in which the plate cylinder 2 is formed, in order to achieve enhancement of the strength of the plate cylinder 2 and enhancement of transferability of the ink 100 onto the material to be printed 200, the surface of the pattern forming plate 5 may be coated with diamond-like carbon or the like.

The example in which the plate cylinder 2 is formed by etching-back and thinning the pattern forming plate 5 is described above. However, for example, a substrate having a thickness of 30 μm may be prepared at first, and without performing etch back, the winding body is formed in the above-described method and wound around the cylindrical member 4 to form the plate cylinder 2.

In addition, in the method of forming the plate cylinder 2 described above, the winding body 16 is joined to the cylindrical member 4 using the adhesive 17. However, as the adhesive 17, for example, a type of which the adhesion is degraded by the addition of a peeling agent, the irradiation of UV rays, heating, or cooling may also be used.

As the type of which the adhesion is degraded by the addition of a peeling agent, the irradiation of UV rays, heating, or cooling is used as the adhesive 17 as described above, for example, when breaking or damage occurs in the pattern forming plate 5, the pattern forming plate 5 may be peeled off from the cylindrical member 4 by performing the addition of a peeling agent, the irradiation of UV rays, heating, or cooling on the adhesive 17, and a new pattern forming plate 5 may be adhered to the cylindrical member 4. As the new pattern forming plate 5 is adhered to the cylindrical member 4, the plate cylinder 2 does not have to be replaced when breaking or damage occurs in the pattern forming plate 5, and only the pattern forming plate 5 may be replaced. Therefore, a reduction in costs during a printing operation using the plate cylinder 2 can be achieved.

In addition, the example in which etching (dry etching) is performed using the plasma etching apparatus in the method of forming the pattern 5c on the substrate 10 is described above. However, the method of forming the pattern 5c on the substrate 10 is not limited to the dry etching using the plasma etching apparatus. For example, as the method of forming the pattern 5c, a method of cutting the substrate 10 using 6-axis NC (Numerical Control) machine tools such as a milling machine, or a method of etching the substrate 10 by hydrofluoric acid etching may also be used.

### Modified Example of Method of Forming Plate Cylinder

Hereinafter, a modified example of the method of forming the plate cylinder 2 will be described (see FIGS. 3 to 12 and FIGS. 18 to 23).

In the modified example of the forming method described as follows, processes before performing etch back are the same as those in the above-described forming method (see FIGS. 3 to 12), so that only processes after the process of performing etch back will be described hereinafter.

In the modified example of the method of forming the plate cylinder 2, the cylindrical member 4 and the substrate 10 are formed of different materials from each other, and with regard to the materials of the cylindrical member 4 and the substrate 10, the substrate 10 uses a material having a smaller adhesion to the ink 100 used for printing than that of the cylindrical member 4.

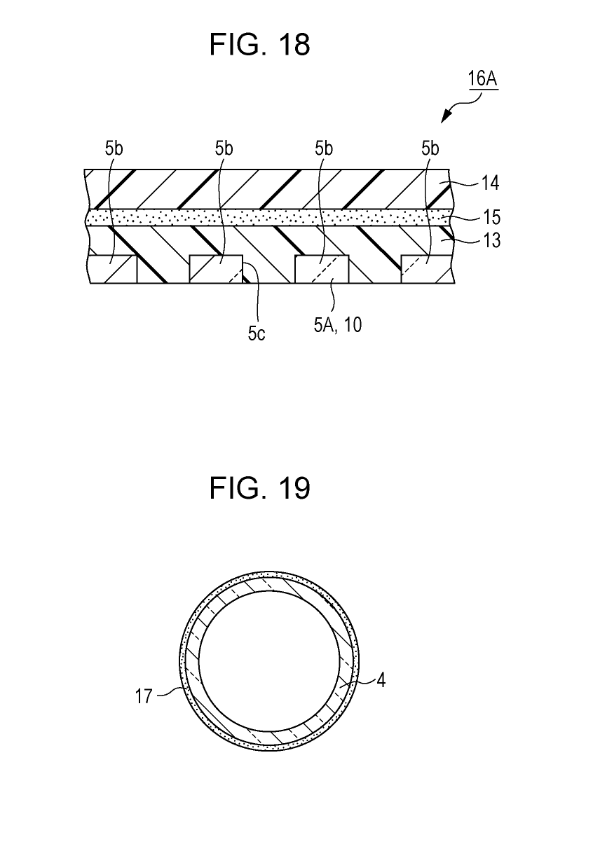

The protective sheet 14 is adhered to the surface of the resist 13 by the adhesive 15 (see FIG. 12). Thereafter, the lower surface (the surface on the opposite side to the side where the resist 13 is applied) of the pattern forming plate 5′ is immersed into a hydrofluoric acid solution having a bubbling function, and etch back is performed to remove the base portion 5a′ of the pattern forming plate 5′ (see FIG. 18). As the base portion 5a′ of the pattern forming plate 5′ is etch-backed and removed, a pattern forming plate 5A is formed, and the pattern forming plate 5A has a thickness of, for example, 5 μm. In the case where a material having a low etching rate in regard to the hydrofluoric acid solution, such as quartz glass, is used for the substrate 10, for example, the base portion 5a′ may be polished in advance by a polishing apparatus, and thereafter etch back may be performed using the hydrofluoric acid solution. As the pattern forming plate 5A is formed by performing etch back and thinning the pattern forming plate 5′ as described above, a winding body 16A made by adhering the resist 13 and the protective sheet 14 on the pattern forming plate 5A is configured.

Thereafter, the cylindrical member 4 is prepared (see FIG. 19). The cylindrical member 4, for example, has a diameter of 150 mm and an axial length of 300 mm. The adhesive 17, for example, a UV curing adhesive is applied on the outer peripheral surface of the prepared cylindrical member 4.

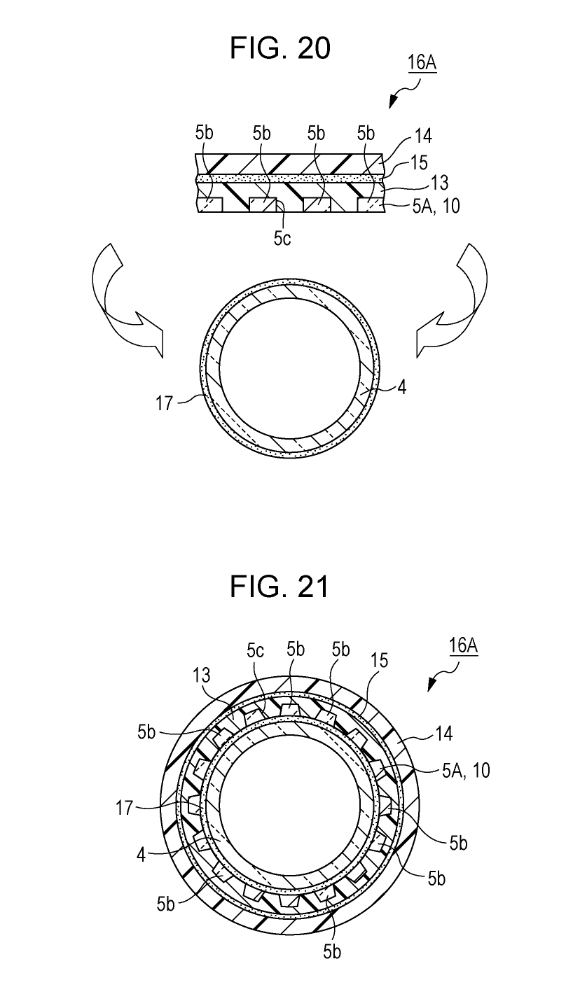

Subsequently, the winding body 16A is bent and wound around the cylindrical member 4 (see FIG. 20). Here, the winding body 16A has to be wound around the cylindrical member 4 with high position precision, and for example, it is preferable that the winding body 16A be irradiated with a laser beam in advance to form a positioning hole and a positioning hole be formed in the cylindrical member 4 in advance. As the positioning holes are formed in the winding body 16A and the cylindrical member 4, a positioning pin (tapered pin) made of glass may be inserted into the two positioning holes so as to accurately position the winding body 16A with respect to the cylindrical member 4.

Thereafter, the adhesive 17 is cured by irradiating the winding body 16A from the outer peripheral surface side with UV rays so as to adhere the winding body 16A to the cylindrical member 4 (see FIG. 19). After adhering the winding body 16A to the cylindrical member 4, the positioning pin is pulled out from the positioning holes.

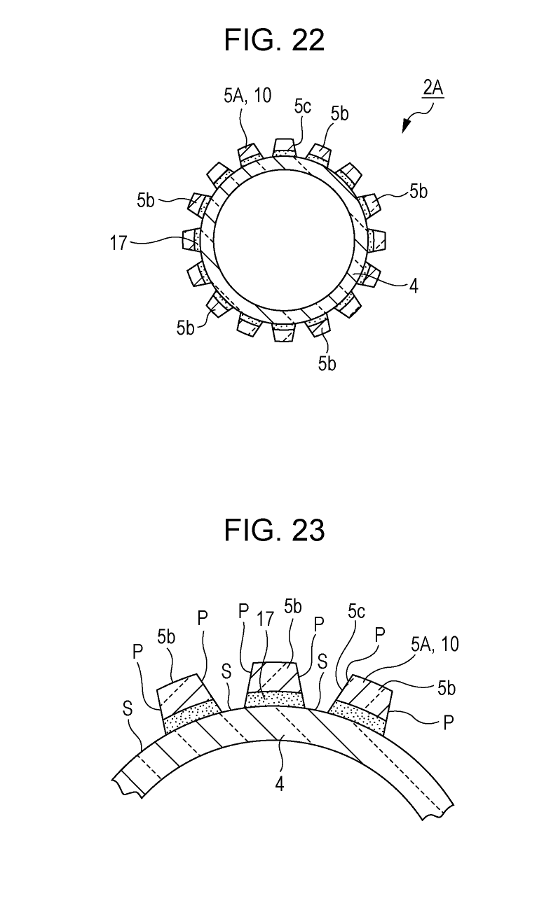

Thereafter, the winding body 16A and the cylindrical member 4 are immersed into an ultrasonic washing tub filled with acetone or a resist peeling agent, and the resist 13 for lift-off is removed (see FIG. 22). At the time of removing the resist 13, the protective sheet 14 is simultaneously peeled off, such that the adhesive 15 positioned on the pattern 5c is also removed. As the resist 13 of the winding body 16A is removed and the protective sheet 14 is peeled off as described above, the pattern forming plate 5A in which the pattern 5c for printing is formed is left, thereby forming a plate cylinder 2A in which the pattern forming plate 5A is wound around and joined to the cylindrical member 4.

In a state in which the plate cylinder 2A is formed, in order to achieve enhancement of the strength of the plate cylinder 2A and enhancement of transferability of the ink 100 onto the material to be printed 200, the surface of the pattern forming plate 5A may be coated with diamond-like carbon or the like.

In the method of forming the plate cylinder 2A described above, the winding body 16A is joined to the cylindrical member 4 using the adhesive 17. However, as the adhesive 17, for example, a type of which the adhesion is degraded by the addition of a peeling agent, the irradiation of UV rays, heating, or cooling may also be used.

As the type of which the adhesion is degraded by the addition of a peeling agent, the irradiation of UV rays, heating, or cooling is used as the adhesive 17 as described above, for example, when breaking or damage occurs in the pattern forming plate 5A, the pattern forming plate 5A may be peeled off from the cylindrical member 4 by performing the addition of a peeling agent, the irradiation of UV rays, heating, or cooling on the adhesive 17, and a new pattern forming plate 5A may be adhered to the cylindrical member 4. As the new pattern forming plate 5A is adhered to the cylindrical member 4, the plate cylinder 2A does not have to be replaced when breaking or damage occurs in the pattern forming plate 5A, and only the pattern forming plate 5A has to be replaced. Therefore, a reduction in costs during a printing operation using the plate cylinder 2A can be achieved.

As described above, since the plate cylinder 2A is configured of only the protruding portions 5b, 5b, . . . , as shown in FIG. 23, the recessed portions of the pattern 5c are formed of side surfaces P, P, . . . of the protruding portions 5b, 5b, . . . and outer peripheral surfaces S, S, . . . of the cylindrical member 4. Here, as described above, as the materials of the cylindrical member 4 and the substrate 10, the substrate 10 uses a material having a smaller adhesion to the ink 100 used for printing than that of the cylindrical member 4.

Therefore, the side surfaces P, P, . . . have a smaller adhesion to the ink 100 of the pattern 5c than that of the outer peripheral surfaces S, S, . . . , so that good receptivity (transferability) of the ink 100 to the blanket roll 3 is ensured, thereby ensuring good printing precision of the material to be printed 200.

### CONCLUSION

As described above, the plate cylinders 2 and 2A are respectively configured by bending the pattern forming plates 5 and 5A to be wound around and joined to the outer peripheral surface of the cylindrical member 4.

Therefore, the pattern 5c for printing may be formed on the flat plate-shaped substrate 10, and the pattern for printing does not have to be formed on the outer peripheral surface of a cylindrical base material, so that a precise pattern 5c for printing can be formed without causing an increase in manufacturing costs.

In addition, since the pattern forming plates 5 and 5A are formed by etching (etching-back) and thinning the substrate 10, forming and thinning of the pattern forming plates 5 and 5A can be easily performed, and degree of freedom in designing the thicknesses of the pattern forming plates 5 and 5A can be enhanced.

The present disclosure contains subject matter related to that disclosed in Japanese Priority Patent Application JP 2010-163993 filed in the Japan Patent Office on Jul. 21, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A plate cylinder comprising:
a cylindrical member; and
a pattern forming plate configured by forming a predetermined pattern for printing on a flat plate-shaped substrate using microfabrication,
wherein the pattern forming plate is bent, and wound around and joined to an outer peripheral surface of the cylindrical member.

2. The plate cylinder according to claim 1, wherein the cylindrical member and the pattern forming plate are formed of a glass material.

3. The plate cylinder according to claim 1, wherein the cylindrical member and the pattern forming plate are formed of the same material.

4. The plate cylinder according to claim 1, wherein the pattern forming plate is formed by etching and thinning the substrate.

5. The plate cylinder according to claim 1, wherein the pattern forming plate is joined to the outer peripheral surface of the cylindrical member by an adhesive of which adhesion is degraded by addition of a peeling agent, irradiation of UV rays, heating, or cooling.

6. The plate cylinder according to claim 1,
wherein the predetermined pattern is formed of a plurality of recessed portions that communicate with the outer peripheral surface of the cylindrical member, and
the pattern forming plate has a smaller adhesion to ink filling the recessed portions than that of the cylindrical member.

7. A printing apparatus comprising:
a plate cylinder which includes a cylindrical member, and a pattern forming plate configured by forming a predetermined pattern for printing on a flat plate-shaped substrate using microfabrication, the pattern forming plate being bent, and wound around and joined to an outer peripheral surface of the cylindrical member,
wherein printing is performed on a material to be printed as the plate cylinder is rotated.

8. A method of forming a plate cylinder comprising:
forming a pattern forming plate by forming a predetermined pattern for printing on a flat plate-shaped substrate using microfabrication; and
bending the pattern forming plate and winding and joining the pattern forming plate to an outer peripheral surface of a cylindrical member so as to be formed.
